(19) United States
(12) Patent Application Publication
(10) Pub. No.: US 2009/0024751 A1
(43) Pub. Date: Jan. 22, 2009

(54) INTERMEDIARY SERVER, METHOD FOR CONTROLLING INTERMEDIARY SERVER, AND PROGRAM FOR CONTROLLING INTERMEDIARY SERVER

(75) Inventors: Shinya TANIGUCHI, Matsumoto (JP); Senichi MOKUYA, Shiojiri (JP); Naruhide KITADA, Fujimi (JP); Yusuke TAKAHASHI, Matsumoto (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/173,858

(22) Filed: Jul. 16, 2008

(30) Foreign Application Priority Data
Jul. 18, 2007 (JP) 2007-186614

(51) Int. Cl. H04L 9/32

(52) U.S. Cl. 709/229

(57) ABSTRACT

The invention relates to an intermediary server that intermediates between at least one authentication server that performs authentication and a plurality of devices that performs various kinds of processing in accordance with the result of the authentication performed by the authentication server. The invention provides, as an aspect thereof, the intermediary server that includes: a request reception unit that receives authentication request data from any of the plurality of devices, the authentication request data being created in a predetermined common data format in such a manner that the authentication request data contains, without any limitation thereto, identification information that was inputted into the above-mentioned one of the plurality of devices; an authentication server communication unit that transmits the received identification information to the authentication server in a data format that can be processed by the authentication server and then receives, from the authentication server, the result of authentication performed by the authentication server on the basis of the transmitted identification information; and a result transmission unit that transmits the received result of the authentication to the above-mentioned one of the plurality of devices that is the original sender of the authentication request data.

### BACKGROUND

1. Technical Field

The present invention generally relates to an intermediary server, a method for controlling an intermediary server, and a program for executing such a controlling method. More particularly, the invention relates to an intermediary server that intermediates between at least one authentication server that performs authentication and a plurality of client devices that performs various kinds of processing in accordance with the result of the authentication performed by the authentication server. In addition, the invention further relates to a method for controlling such an intermediary server, and a program that causes at least one computer to execute the steps of such a controlling method.

In the following description of this specification and, in especially, the recitation of appended claims, the term “intermediary server” is used as a broad and generic concept that includes, without any limitation thereto, an intermediate server, an intermediation server, a mediation server, a coordinator server, and a coordination server. That is, this term encompasses a wide variety of servers, without any limitation to those enumerated above, that intermediate between at least one authentication server that performs authentication and a plurality of client devices that performs various kinds of processing in accordance with the result of the authentication performed by the authentication server. In addition, the term “authentication server” includes but not limited to a certification server.

2. Related Art

In the technical field to which the present invention pertains, there are some network devices that require user authentication before use for security reasons. For example, a network device of the related art reads an authentication ID out of an authentication target medium such as an ID card or the like and makes an inquiry to a user management database on the basis of the read authentication ID for user authentication. The authentication ID is unique to each authentication target medium. Another network device of the related art disclosed in JP-A-2004-129247 provides multiple authentications: specifically, the network device of the related art disclosed in JP-A-2004-129247, which has a plurality of applications, receives the result of authentication(s) from a plurality of authentication systems and restricts the use of the plurality of applications on the basis of the received result thereof.

In a network environment where there is a plurality of network devices that requires user authentication prior to the use of its function(s), each network device performs format conversion on a read-out authentication ID so that it conforms to the data format accessible by the individual user management database before transmission thereof to the user management database. If, for any reason, the original data format is changed into another data format, it is necessary to change the configuration (i.e., setting) of all network devices, which is extremely burdensome. The same problem as that described above arises when another authentication server is added.

### SUMMARY

An advantage of some aspects of the invention is to provide an intermediary server that intermediates between at least one authentication server that performs authentication and a plurality of client devices that performs various kinds of processing in accordance with the result of the authentication performed by the authentication server. More specifically, as an advantage of some aspects thereof, the invention provides an intermediary server that has an intermediary function described above and is capable of releasing users from the burden of setting changes when an original data format that can be processed by an individual authentication server is changed for any reason into another data format or when there is an addition of another authentication server. In addition, the invention further relates to a method for controlling such an intermediary server, and a program that causes at least one computer to execute the steps of such a controlling method.

In order to address the above-identified problems without any limitation thereto, the invention adopts any of the following novel and inventive configurations and features.

The invention provides, as a first aspect thereof, an intermediary server that intermediates between at least one authentication server that performs authentication and a plurality of devices that performs various kinds of processing in accordance with the result of the authentication performed by the authentication server, the intermediary server including: a request receiving section that receives authentication request data from any of the plurality of devices, the authentication request data being created in a predetermined common data format in such a manner that the authentication request data contains, without any limitation thereto, identification information that was inputted into the above-mentioned one (i.e., above-mentioned any) of the plurality of devices; an authentication server communicating section that transmits the received identification information to the authentication server in a data format that can be processed by the authentication server and then receives, from the authentication server, the result of authentication performed by the authentication server on the basis of the transmitted identification information; and a result transmitting section that transmits the received result of the authentication to the above-mentioned one of the plurality of devices that is the original sender of the authentication request data.

In the configuration of an intermediary server according to the first aspect of the invention described above, a request receiving section receives authentication request data from any of the plurality of devices, where the authentication request data is created in a predetermined common data format in such a manner that the authentication request data contains, without any limitation thereto, identification information that was inputted into the above-mentioned one of the plurality of devices (or identification information that is unique to the above-mentioned one of the plurality of devices). A non-limiting example of the predetermined common data format is an XML data format. An authentication server communicating section transmits the received identification information to the authentication server in a data format that can be processed by the authentication server and then receives, from the authentication server, the result of authentication performed by the authentication server on the basis of the transmitted identification information. A result transmitting section transmits the received result of the authentication to the above-mentioned one of the plurality of devices that is the original sender of the authentication request data. That is, an intermediary server according to the first aspect of the invention described above receives authentication request data that is created in a common data format from any of a plurality of devices. On the other hand, an intermediary server according to the first aspect of the invention described above transmits identification information to the authentication server in a data format that conforms to one that can be processed by the authentication server. Therefore, when an original data format that conforms to one which is accessible (can be processed) by the authentication server is changed for any reason into another data format or when there is an addition of another authentication server, it is not necessary to change the setting/configuration of each of the plurality of devices on an individual basis. That is, when such change or addition occurs, it is possible to make an authentication system work by merely changing the setting/configuration of the intermediary server according to the first aspect of the invention described above (only). For this reason, the intermediary server according to the first aspect of the invention described above releases users from the burden of setting changes when such change or addition occurs.

The authentication server may be a server that performs authentication as to whether a certain user is a valid user or not, that is, an authorized/registered user or not. For example, the authentication server may be a user authentication server, though not limited thereto. Or, as another non-limiting example thereof, the authentication server may be a server that makes a judgment as to the approval/disapproval of use. For example, the authentication server may be an accounting server or a device authentication server, though not limited thereto. The data format includes, in addition to a data storage format, a communication format such as a protocol and the like.

It is preferable that the intermediary server according to the first aspect of the invention described above should further include: a correspondence storing section that pre-stores correspondences between determination information, which enables a determination of the authentication server, and the authentication server; and a correspondence setting section that enables a new correspondence to be registered into the correspondence storing section and further enables any correspondence that is registered in the correspondence storing section to be changed or deleted, wherein the above-mentioned at least one authentication server is not one but more than one authentication server; the request receiving section receives authentication request data from any of the plurality of devices, the authentication request data being created in the predetermined common data format in such a manner that the authentication request data contains, without any limitation thereto, identification information that was inputted into the above-mentioned one of the plurality of devices and the determination information; and the authentication server communicating section determines the authentication server that corresponds to the received determination information on the basis of correspondences stored in the correspondence storing section, transmits the received identification information to the determined authentication server in a data format that can be processed by the determined authentication server, and then receives, from the determined authentication server, the result of authentication performed by the determined authentication server on the basis of the transmitted identification information. With the preferred configuration of an intermediary server according to the first aspect of the invention described above, it is possible to produce the advantageous effects of the invention even when an authentication system includes two or more authentication servers.

The plurality of authentication servers may be made up of two or more authentication servers of the same kind/type. Or, alternatively, the plurality of authentication servers may be made up of two or more authentication servers of different kinds/types. The identification information and the determination information may be separated from each other. Or, alternatively, one of the identification information and the determination information may double as, for example, contain, the other.

In the preferred configuration of an intermediary server that is connected not to only one authentication server but to more than one authentication server as described above, it is further preferable that the above-mentioned more than one authentication server should include but not limited to at least one user authentication server that performs user authentication and a device authentication server that performs device authentication; the request receiving section should receive authentication request data from any of the plurality of devices, the authentication request data being created in the predetermined common data format in such a manner that the authentication request data contains, without any limitation thereto, identification information that was inputted into the above-mentioned one of the plurality of devices, identification information that is unique to the above-mentioned one of the plurality of devices, and the determination information; the authentication server communicating section should transmit the received device identification information to the device authentication server in a data format that can be processed by the device authentication server and then should receive, from the device authentication server, the result of device authentication performed by the device authentication server on the basis of the transmitted device identification information; and the authentication server communicating section should determine, if the received result of the device authentication is a success, the user authentication server that corresponds to the received determination information on the basis of correspondences stored in the correspondence storing section, should transmit the received identification information to the determined user authentication server in a data format that can be processed by the determined user authentication server, and then should receive, from the determined user authentication server, the result of user authentication performed by the determined user authentication server on the basis of the transmitted identification information. With such a preferred configuration, it is possible to perform user authentication only for some devices that are listed as the target of user authentication.

In the preferred configuration of an intermediary server that is connected not to only one authentication server but to more than one authentication server, it is further preferable that the correspondence storing section should pre-store the correspondences in the form of script file(s). An example of the script file is a macro file, though not necessarily limited thereto. With the preferred configuration of an intermediary server described above, when an original data format that conforms to one which is accessible (can be processed) by the authentication server is changed for any reason into another data format or when there is an addition of another authentication server, it is not necessary to change the setting/configuration of each of the plurality of devices on an individual basis. That is, when such change or addition occurs, it is possible to make an authentication system work by merely changing or deleting the script file that is stored in a memory/storage unit or adding another script file into the memory/storage unit. For this reason, the intermediary server having a preferred configuration described above releases users from the burden of setting changes when such change or addition occurs.

The invention provides, as a second aspect thereof, a method for controlling, by means of a computer software, an intermediary server that intermediates between at least one authentication server that performs authentication and a plurality of devices that performs various kinds of processing in accordance with the result of the authentication performed by the authentication server, the intermediary server controlling method including: (a) receiving authentication request data from any of the plurality of devices, the authentication request data being created in a predetermined common data format in such a manner that the authentication request data contains, without any limitation thereto, identification information that was inputted into the above-mentioned one of the plurality of devices; (b) transmitting the received identification information to the authentication server in a data format that can be processed by the authentication server and then receiving, from the authentication server, the result of authentication performed by the authentication server on the basis of the transmitted identification information; and (c) transmitting the received result of the authentication to the above-mentioned one of the plurality of devices that is the original sender of the authentication request data.

In an intermediary server controlling method according to the second aspect of the invention described above, an intermediary server receives authentication request data from any of the plurality of devices, where the authentication request data is created in a predetermined common data format in such a manner that the authentication request data contains, without any limitation thereto, identification information that was inputted into the above-mentioned one of the plurality of devices (or identification information that is unique to the above-mentioned one of the plurality of devices). A non-limiting example of the predetermined common data format is an XML data format. The intermediary server transmits the received identification information to the authentication server in a data format that can be processed by the authentication server and then receives, from the authentication server, the result of authentication performed by the authentication server on the basis of the transmitted identification information. The intermediary server transmits the received result of the authentication to the above-mentioned one of the plurality of devices that is the original sender of the authentication request data. That is, in an intermediary server controlling method according to the second aspect of the invention described above, the intermediary server receives authentication request data that is created in a common data format from any of a plurality of devices. On the other hand, in an intermediary server controlling method according to the second aspect of the invention described above, the intermediary server transmits identification information to the authentication server in a data format that conforms to one that can be processed by the authentication server. Therefore, when an original data format that conforms to one which is accessible (can be processed) by the authentication server is changed for any reason into another data format or when there is an addition of another authentication server, it is not necessary to change the setting/configuration of each of the plurality of devices on an individual basis. That is, when such change or addition occurs, it is possible to make an authentication system work by merely changing the setting/configuration of the intermediary server according to the first aspect of the invention described above. For this reason, the intermediary server controlling method according to the second aspect of the invention described above releases users from the burden of setting changes when such change or addition occurs. It should be noted that further step(s) may be added to the above-described basic steps of an intermediary server controlling method according to the second aspect of the invention in order to realize operation/working-effects and/or functions that are offered by constituent elements of an intermediary server according to the first aspect of the invention described above.

The invention provides, as a third aspect thereof, a program that causes at least one computer to execute the steps of an intermediary server controlling method according to the second aspect of the invention described above. In its practical implementation, such a program may be stored in a computer-readable recording medium (e.g., a hard disk, ROM, FD, CD, DVD, and the like). Alternatively, it may be distributed from one computer to another computer via a transmission medium (a communication network such as the Internet, LAN, or the like). Notwithstanding the above, it may be sent/received through any other alternative means. With the above-mentioned program being executed either by a single personal computer or by plural personal computers (e.g., in a distributed topology), the operation steps of a method for controlling an intermediary server according to the second aspect of the invention described above are performed/executed by one or more personal computers. Thus, a program according to the third aspect of the invention described above offers/produces the same operation/working-effects that are achieved by an intermediary server controlling method according to the second aspect of the invention described above.

### BRIEF DESCRIPTION OF THE DRAWINGS

The invention will be described with reference to the accompanying drawings, wherein like numbers reference like elements.

FIG. 1 is a diagram that schematically illustrates an example of the configuration of an authentication system 100 that includes an intermediary server 10 according to an exemplary embodiment of the invention.

FIG. 2 is a functional block diagram that schematically illustrates an example of the functional configuration of the intermediary server 10 according to an exemplary embodiment of the invention as well as the functional configuration of a first user authentication server 20 and a first MFP 50.

FIG. 3 is a table that shows an example of relationships/correspondences between application IDs and content of processing according to an exemplary embodiment of the invention.

FIG. 4 is a table that shows an example of a macro-setting table according to an exemplary embodiment of the invention.

FIG. 5 is a table that shows an example of functions presented/provided by server modules according to an exemplary embodiment of the invention.

FIG. 6 is a table that shows an example of a user information table according to an exemplary embodiment of the invention.

FIG. 7 is an explanatory diagram that schematically illustrates an example of the sequence/flow of data communication conducted by the authentication system 100, or more specifically, the sequence/flow of intermediary data communication conducted by the intermediary server 10 according to an exemplary embodiment of the invention.

FIG. 8 is a diagram that schematically illustrates an example of authentication request data according to an exemplary embodiment of the invention.

FIG. 9 is a diagram that schematically illustrates an example of a macro file according to an exemplary embodiment of the invention.

FIG. 10 is a diagram that schematically illustrates another example of authentication request data according to an exemplary embodiment of the invention.

FIG. 11 is a diagram that schematically illustrates an example of the configuration of an authentication system 110 that includes (but not limited to) a device authentication server 70 in addition to the intermediary server 10 according to an exemplary embodiment of the invention.

FIG. 12 is an explanatory diagram that schematically illustrates an example of the sequence/flow of data communication conducted by the authentication system 110, or more specifically, the sequence/flow of intermediary data communication conducted by the intermediary server 10 according to an exemplary embodiment of the invention.

### DESCRIPTION OF EXEMPLARY EMBODIMENTS

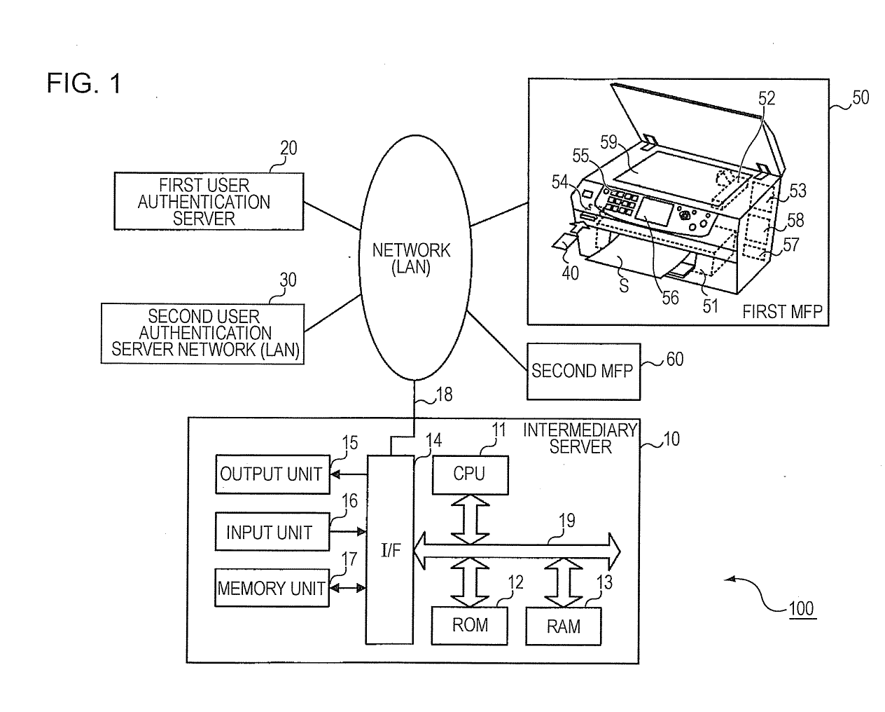

With reference to the accompanying drawings, an exemplary embodiment of the present invention is explained in detail below. FIG. 1 is a diagram that schematically illustrates an example of the configuration of an authentication system 100 that includes an intermediary server 10 according to an exemplary embodiment of the invention.

The authentication system 100 includes but not limited to the intermediary server 10 according to the present embodiment of the invention, a first user authentication server 20, a second user authentication server 30, a first multifunction printer 50, and a second multifunction printer 60. These system components are interconnected to one another via, for example, a wired or wireless LAN network. With such network connection, the first and second user authentication servers 20 and 30, the intermediary server 10, and the first and second multifunction printers 50 and 60 can communicate with one another (from the multifunction printer to the intermediary server and vice versa, and from the intermediary server to the user authentication server and vice versa). In the following description as well as in the accompanying drawings, the term “multifunction printer” is abbreviated as MFP.

The intermediary server 10 is a server that intermediates between at least one user authentication server and client devices. In the exemplary configuration of the authentication system 100 described herein, the intermediary server 10 intermediates between the first and second user authentication servers 20 and 30 and the first and second MFPs 50 and 60. The intermediary server 10 is provided with a CPU 11, a ROM 12, a RAM 13, and an I/F 14. The CPU 11 is responsible for controlling the entire operation of the intermediary server 10 on the basis of a control program. The ROM 12 stores the control program and the like in a predetermined program storage area thereof. The RAM 13 temporarily stores various kinds of data. The I/F 14, which is an input/output interface, is used for inputting data into the intermediary server 10 from other device or outputting data from the intermediary server 10 to other device. The CPU 11, the ROM 12, the RAM 13, and the I/F 14 are interconnected to one another so as to allow internal data communication/transfer inside the intermediary server 10. An output unit 15, an input unit 16, a memory unit 17, and a LAN cable 18 are connected to the I/F 14. The output unit 15 is capable of displaying various kinds of images. An example of the output unit 15 is a liquid crystal display, though not limited thereto. The input unit 16 is used/manipulated/operated at the time when users input data into the intermediary server 10. A few examples of the input unit 16 are, without any limitation thereto, a keyboard and a mouse. The memory unit 17 stores various kinds of data and various kinds of tables, though not limited thereto, in the form of files. A non-limiting example of the memory unit 17 is a hard disk drive. The LAN cable 18 provides connection to the LAN network.

The basic/fundamental configuration of each of the first user authentication server 20 and the second user authentication server 30 is the same as that of the intermediary server 10. For this reason, a detailed explanation thereof is not given herein so as to omit any redundant description.

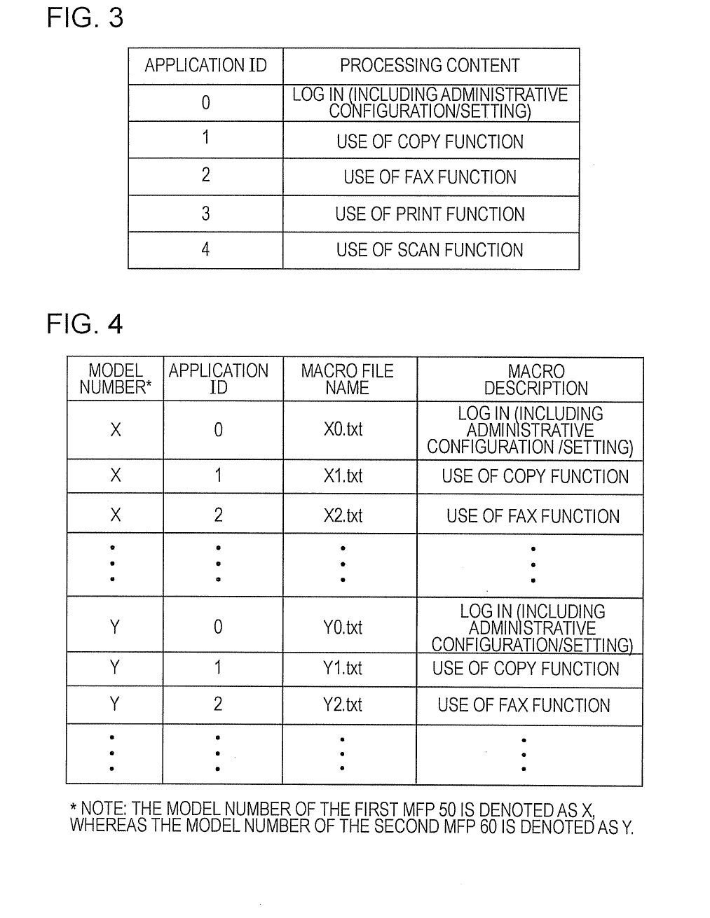

The first MFP 50 is provided with a printer unit 51, a scanner unit 52, a Fax unit 53, a card reader 54, a keyboard 55, a liquid crystal display 56, a LAN interface 57, and a controller 58. The printer unit 51 of the first MFP 50 has a well-known ink-jet color printer mechanism and a printer ASIC. The color printer mechanism of the printer unit 51 performs printing by discharging ink onto a sheet of printing paper S from a print head thereof. The printer ASIC of the printer unit 51 controls the operation of the color printer mechanism thereof. The scanner unit 52 of the first MFP 50 has a well-known color image sensor and a scanner ASIC. The color image sensor of the scanner unit 52 separates (i.e., performs color-separation processing on) the optical components of a reflected light beam into three primary color components of red (R), green (G), and blue (B) so as to obtain scanned data, where the reflected light beam is obtained as a result of the emission of a light beam toward a sheet of scanning target paper that is placed on a glass table 59 of the first MFP 50. The scanner ASIC of the scanner unit 52 controls the operation of the color image sensor thereof. The FAX unit 53 of the first MFP 50 transmits image data such as the scanned data to a FAX transmission destination. The card reader 54 reads an authentication ID out of an ID card 40, which is inserted into the first MFP 50. The authentication ID is unique to each ID card 40. The keyboard 55 allows users to input their own IDs and passwords into the first MFP 50. The liquid crystal display 56 is capable of displaying information related to the operating state of the first MFP 50. The LAN interface 57 is used for connecting the first MFP 50 to the LAN network. The controller 58 controls the operation of each of the units/components 51-57 of the first MFP 50 described above. The controller 58 is provided with, though not necessarily limited thereto, a CPU that controls the entire operation thereof on the basis of a control program, a ROM in which the control program and the like is stored, a RAM that temporarily stores various kinds of data, and a flash memory that allows free writing/erasing of data therein/therefrom and, in addition thereto, retains stored content without any data loss even when power is turned OFF. In addition to the model number of the first MFP 50 and the IP address thereof, “processing application ID numbers”, each of which is predetermined for individual content of processing, are stored in the flash memory. It should be noted that these components of the controller 58 are not illustrated in the accompanying drawings. In the following description, the processing application ID numbers are simply referred to as application ID(s). The relationship/correspondence between the application IDs and the content of processing is shown in the table of FIG. 3.

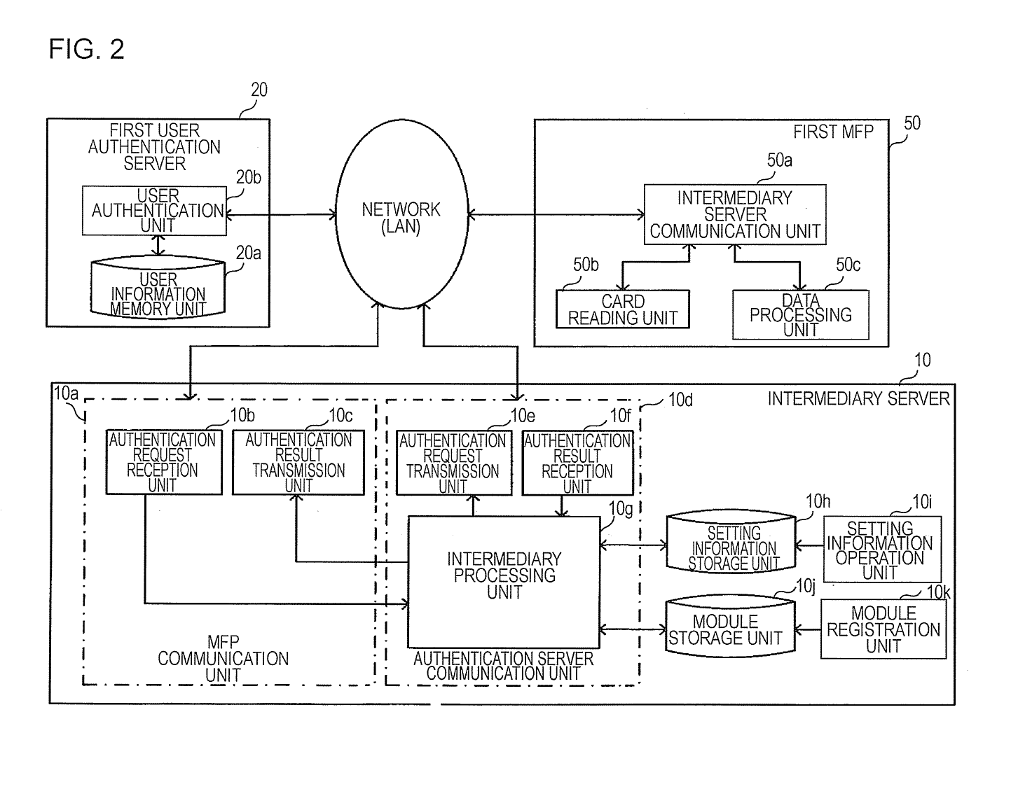

Next, with reference to the functional block diagram of FIG. 2, the functions (including functional configuration and functional operation thereof) of each of the intermediary server 10, the first user authentication server 20, and the first MFP 50 is explained below.

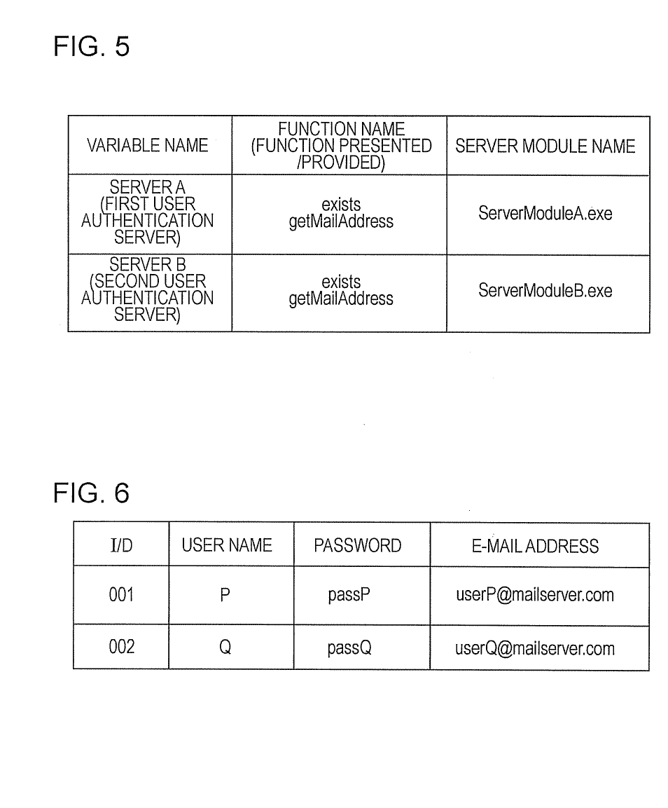

The intermediary server 10 is provided with an MFP communication unit 10a, an authentication server communication unit 10d, a setting information storage unit 10h, and a module storage unit 10j, though not limited thereto. The MFP communication unit 10a of the intermediary server 10 is used for performing network communication with the first MFP 50 and the second MFP 60 (where the first MFP 50 or the second MFP 60 is a communicating party device that is provided at the opposite end of the line/channel of network communication). The authentication server communication unit 10d of the intermediary server 10 is used for performing network communication with the first user authentication server 20 and the second user authentication server 30 (where the first user authentication server 20 or the second user authentication server 30 is a communicating party server that is provided at the opposite end of the line/channel of network communication). The setting information storage unit 10h of the intermediary server 10 stores a macro-setting table. The macro-setting table stored in the setting information storage unit 10h shows correspondence between the model numbers of the MFPs, the application IDs, and macro file names. That is, in the macro-setting table that is stored in the setting information storage unit 10h, macro files are set in association with the model numbers of the MFPs and the application IDs. It should be noted that macro files described herein is a non-limiting example of script files. The module storage unit 10j of the intermediary server 10 stores server modules that are described in the macro files. The MFP communication unit 10a of the intermediary server 10 has an authentication request reception unit 10b. The authentication request reception unit 10b of the MFP communication unit 10a receives authentication request data that is sent from the first MFP 50 or the second MFP 60. The authentication request data sent from the first MFP 50 or the second MFP 60 was (i.e., is) created in a predetermined common data format. The authentication request data sent from the first MFP 50 or the second MFP 60 contains an authentication ID that is unique to the ID card 40 and further contains the model number of the MFP 50/60, the IP address thereof, and an application ID. Or, alternatively, in place of the authentication ID that is unique to the ID card 40, the authentication request data sent from the first MFP 50 or the second MFP 60 contains a user ID and a password that were inputted by a user in addition to the model number of the MFP 50/60, the IP address thereof, and an application ID. The authentication server communication unit 10d of the intermediary server 10 has an intermediary processing unit 10g. The intermediary processing unit 10g of the authentication server communication unit 10d looks up (i.e., makes reference to) the macro-setting table stored in the setting information storage unit 10h so as to find a macro file that is associated with the MFP model number and the application ID that are contained in the authentication request data received at the authentication request reception unit 10b. Then, the intermediary processing unit 10g reads a server module that is described in the found macro file out of the module storage unit 10j and then executes the read-out server module. A non-limiting example of the macro-setting table is shown in the table of FIG. 4. Note that the model number of the first MFP 50 is denoted as X in the table of FIG. 4, whereas the model number of the second MFP 60 is denoted as Y therein. The server module is a communication module that is used for performing network communication with either the first user authentication server 20 or the second user authentication server 30, which is determined (e.g., identified, though not limited thereto) on the basis of the MFP model number and the application ID that are contained in the authentication request data received at the authentication request reception unit 10b. As a non-limiting example of communication protocol thereof, LDAP, which is the acronym of Lightweight Directory Access Protocol, is used. A non-limiting example of functions presented/provided by the server modules is illustrated in the table of FIG. 5. In the table of FIG. 5, “exists” represents the execution of user authentication, whereas “getMailAddress” represents the acquisition of an e-mail address. Through the execution of the server module explained above, the intermediary processing unit 10g of the authentication server communication unit 10d of the intermediary server 10 creates authentication request data that contains the authentication ID (or a combination of the user ID and the password) that conforms to the data format accessible by the determined (e.g., identified, though not limited thereto) user authentication server (it is assumed herein as the first user authentication server 20 just for the purpose of explanation), and then sends the created authentication request data from an authentication request transmission unit 10e of the authentication server communication unit 10d thereof to the determined first user authentication server 20. Subsequently, the authentication server communication unit 10d of the intermediary server 10 receives, at an authentication result reception unit 10f thereof, the results of user authentication performed by the first user authentication server 20. In the description of this specification, the data format “accessible by” the determined user authentication server is used as a non-limiting example of a data format that can be processed by the determined user authentication server. Thereafter, the intermediary processing unit 10g transfers the result of user authentication, which was received as explained above, to the MFP communication unit 10a. Then, the MFP communication unit 10a of the intermediary server 10 sends the result of user authentication from an authentication result transmission unit 10c thereof to the original sender of the aforementioned authentication request data (e.g., the first MFP 50). It should be particularly noted that the authentication result that is sent from the intermediary server 10 to the original sender of the authentication request data is in a common data format.

An operator can enter (i.e., register) new setting information into the setting information storage unit 10h by manipulating a setting information operation unit 10i. In addition, the operator can change and/or delete any setting information that has already been registered in the setting information storage unit 10h by manipulating the setting information operation unit 10i. In like manner, the operator can register a new server module into the module storage unit 10j by manipulating a module registration unit 10k. In addition, the operator can change and/or delete any server module that has already been registered in the module storage unit 10j by manipulating the module registration unit 10k. In the illustration of FIG. 2, each of the MFP communication unit 10a and the authentication server communication unit 10d is a block that functionally represents, mainly, the CPU 11, the ROM 12, the RAM 13, and the I/F 14 shown in FIG. 1. Each of the setting information storage unit 10h and the module storage unit 10j is the functional representation of the memory unit 17 illustrated in FIG. 1. Each of the setting information operation unit 10i and the module registration unit 10k is the functional representation of the input unit 16 illustrated in FIG. 1.

The first user authentication server 20 is provided with a user information memory unit 20a and a user authentication unit 20b. The user information memory unit 20a of the first user authentication server 20 stores a user information table that shows correspondence between authentication IDs, user names, passwords, and e-mail addresses. That is, in the user information table stored in the user information memory unit 20a of the first user authentication server 20, the corresponding user name, the corresponding password, and the corresponding e-mail address are associated with one another for each authentication ID. The user authentication unit 20b of the first user authentication server 20 performs user authentication. A non-limiting example of the user information table is shown in the table of FIG. 6. A valid user, that is, an authorized/registered user, registers their user information into the user information memory unit 20a of the first user authentication server 20 through user registration. The user authentication unit 20b of the first user authentication server 20 performs user authentication on the basis of the result of a judgment made as to whether the authentication ID (or, in place thereof, the user ID and the password) that was received from the intermediary server 10 via the network is registered in the user information table stored in the user information memory unit 20a of the first user authentication server 20 or not. The user information memory unit 20a of the first user authentication server 20 functionally represents a memory unit that is not shown in the drawing. An example of the memory unit is a hard disk drive, though not limited thereto. The user authentication unit 20b of the first user authentication server 20 is a functional unit that represents a CPU, a ROM, and a RAM, which are not illustrated in the drawing.

The first MFP 50 is provided with an intermediary server communication unit 50a, a card reading unit 50b, and a data processing unit 50c. The intermediary server communication unit 50a of the first MFP 50 is capable of performing network communication with the intermediary server 10. The card reading unit 50b of the first MFP 50 reads out the authentication ID of the ID card 40 (refer to FIG. 1). The card reading unit 50b of the first MFP 50 is the functional representation of the aforementioned card reader 54. The data processing unit 50c of the first MFP 50 performs a variety of data processing for copying, faxing, and the like. The intermediary server communication unit 50a of the first MFP 50 acquires the authentication ID of the ID card 40 that was read by the card reading unit 50b. Then, the intermediary server communication unit 50a of the first MFP 50 creates authentication request data that contains the authentication ID, the IP address, the model number, and the application ID in the aforementioned common data format. Subsequently, the intermediary server communication unit 50a of the first MFP 50 transmits the created authentication request data to the intermediary server 10. Upon reception of the result of authentication from the intermediary server 10, the intermediary server communication unit 50a of the first MFP 50 causes the data processing unit 50c thereof to perform data processing in accordance with the received result of authentication. The intermediary server communication unit 50a of the first MFP 50 is a functional unit that represents the aforementioned LAN interface 57 and the aforementioned controller 58. The data processing unit 50c of the first MFP 50 is a functional unit that represents the aforementioned printer unit 51, the aforementioned scanner unit 52, and the aforementioned Fax unit 53, though not limited thereto.

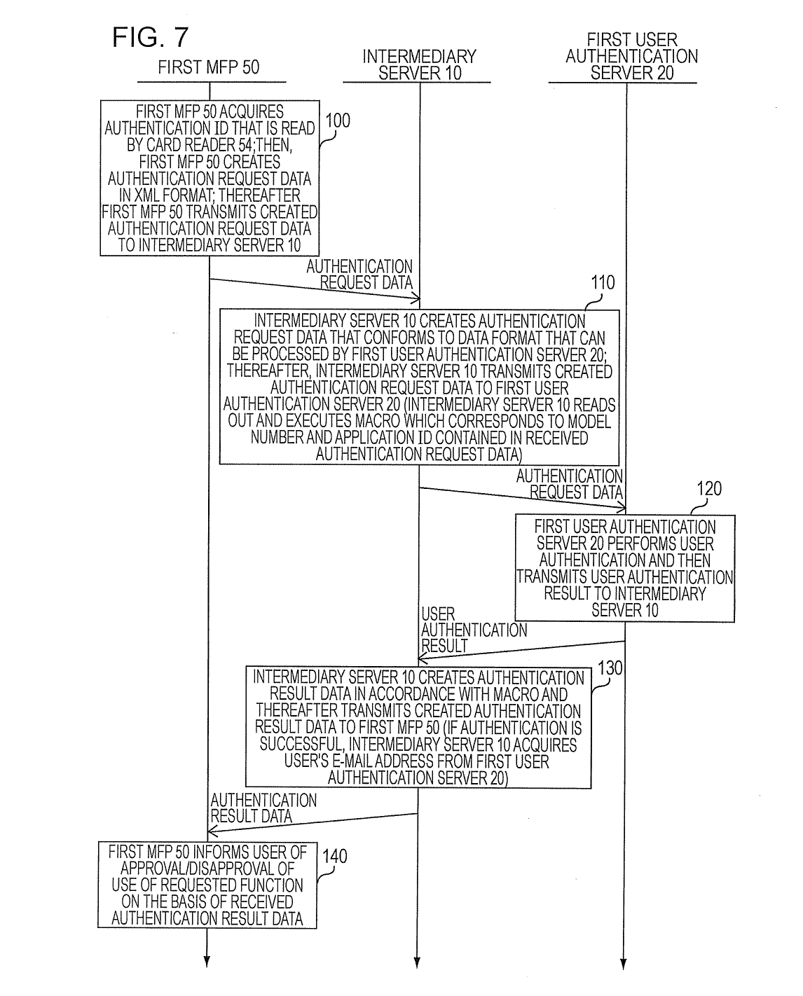

Next, with reference to FIG. 7, the operation of the intermediary server 10 according to the present embodiment of the invention, which has the structural and functional components/units explained above, is explained. In the following description, the operation of the intermediary server 10 according to the present embodiment of the invention is explained while taking an example of the reception of authentication request data from the first MFP 50. FIG. 7 is an explanatory diagram that schematically illustrates an example of the sequence/flow of intermediary data communication conducted by the intermediary server 10 according to the present embodiment of the invention.

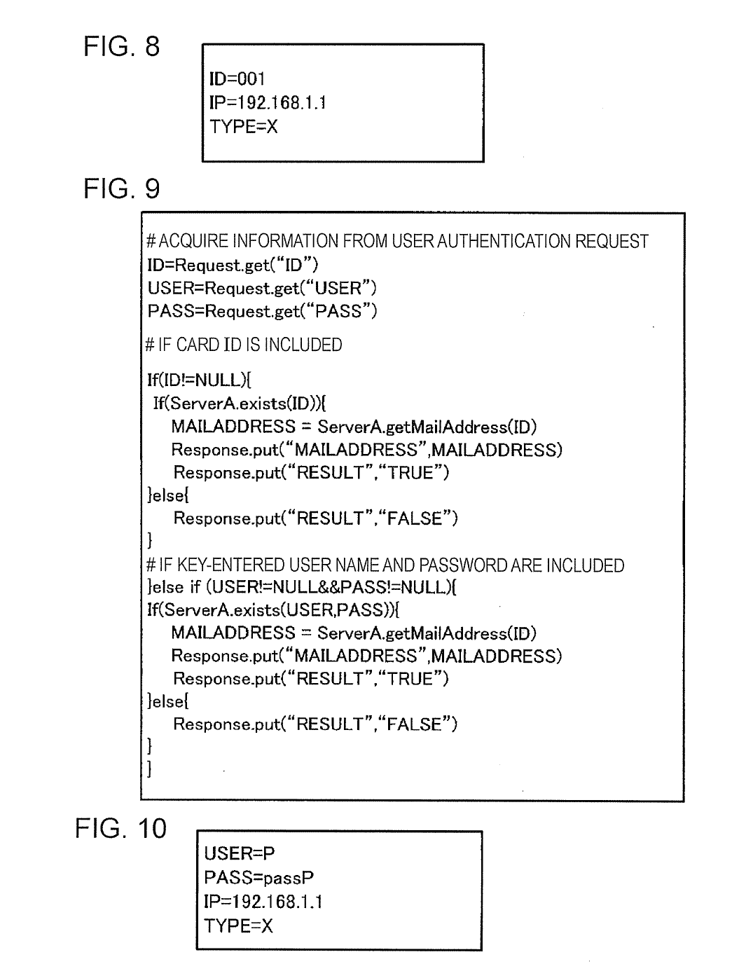

It is assumed herein that, in a user-authentication standby operation status/mode of the first MFP 50 in which the liquid crystal display 56 thereof displays a standby image/screen while waiting for user instructions for authentication, a user has now inserted their ID card 40 into the card reader 54 of the first MFP 50 for the purpose of log in (i.e., login operation) and administrative configuration/setting. It is further assumed herein that the authentication ID of the ID card 40 inserted into the card reader 54 of the first MFP 50 by this user is 001. Upon the recognition of the insertion of the ID card 40 into the card reader 54 thereof, the first MFP 50 acquires the authentication ID of the ID card 40 that is read by the card reader 54. Then, the first MFP 50 creates, in the aforementioned common data format, authentication request data that includes the acquired authentication ID, the IP address, the model number “X”, and the application ID “0”, which indicates log in (refer to the table of FIG. 3). Thereafter, the first MFP 50 transmits the created authentication request data to the intermediary server 10. The above-explained series of the acquisition of the authentication ID, the creation of the authentication request data, and the transmission thereof constitutes the first step of the data communication flow described herein (step S100). A non-limiting example of the authentication request data that is transmitted in this step is illustrated in FIG. 8.

The intermediary server 10 takes the authentication ID, the IP address, the model number X, and the application ID 0 out of the received authentication request data. Then, while making reference to (i.e., looking up) the aforementioned macro-setting table that is shown in FIG. 4, the intermediary server 10 reads out the macro file name “X0.txt”, which corresponds to, that is, associated with, the model number X and the application ID 0. FIG. 9 is an explanatory diagram that shows an example of the macro file that is read out by the intermediary server 10. The intermediary server 10 performs processing in accordance with the content of the macro file. Specifically, since the authentication ID is not NULL in the example described herein, the intermediary server 10 creates authentication request data (including the authentication ID) that conforms to a data format that can be processed by the first user authentication server 20; and thereafter, the intermediary server 10 transmits the created authentication request data to the first user authentication server 20 (step S110). Upon reception of the authentication request data from the intermediary server 10, the first user authentication server 20 performs user authentication and then transmits the result of the user authentication to the intermediary server 10 (step S120). Specifically, in this step S120, the first user authentication server 20 makes reference to the aforementioned user information table illustrated in FIG. 6 so as to make a judgment as to whether the authentication ID that is included in the received authentication request data is registered therein or not. If the authentication ID is registered in the user information table, the first user authentication server 20 outputs a favorable authentication result that approves the authentication request. On the other hand, the first user authentication server 20 outputs an unfavorable authentication result that disapproves the authentication request if the authentication ID is not registered in the user information table. Then, the first user authentication server 20 transmits the result of the authentication, which is either authentication OK or authentication NG, to the intermediary server 10. Upon reception of the result of authentication from the first user authentication server 20, the intermediary server 10 creates authentication result data in accordance with the above-mentioned macro, and thereafter transmits the created authentication result data to the first MFP 50 (step S130). Specifically, in this step S130, if the result of the authentication is a success (i.e., OK), the intermediary server 10 acquires ID-related information, which pertains to the authentication ID, from the first user authentication server 20 and then sends the successful authentication result together with the ID-related information to the first MFP 50 as the authentication result data mentioned above. In a non-limiting exemplary data communication flow described herein, the intermediary server 10 acquires the e-mail address of the user as the ID-related information mentioned above from the first user authentication server 20 and then sends the authentication result together with the acquired e-mail address to the first MFP 50 as the authentication result data mentioned above. On the other hand, if the result of the authentication is a failure (i.e., NG), the intermediary server 10 sends the unsuccessful authentication result to the first MFP 50 as the authentication result data mentioned above. The first MFP 50 informs the user of the approval/disapproval of the use of the requested function on the basis of the received authentication result data (step S140). Specifically, in this step S140, the first MFP 50 analyzes the received authentication result data. If the result of the authentication is a success, the first MFP 50 displays a message that approves the requested log in and administrative configuration/setting on the liquid crystal display 56. In this case, the first MFP 50 accepts (i.e., waits for) user login operation and administrative configuration/setting. On the other hand, if the result of the authentication is a failure, the first MFP 50 displays a message that disapproves the requested log in and administrative configuration/setting on the liquid crystal display 56. In this case, the first MFP 50 will reject user login operation and administrative configuration/setting even if it is attempted. As explained above, if the result of the authentication is a success, the intermediary server 10 acquires the e-mail address of the user as the ID-related information mentioned above from the first user authentication server 20 and then sends the authentication result together with the acquired e-mail address to the first MFP 50 as the authentication result data mentioned above. This e-mail address can be used, for example, at the time when a so-called “scan-to-mail” function is used, though not limited thereto.

In the foregoing description of the sequence/flow of intermediary data communication conducted by the intermediary server 10 according to the present embodiment of the invention, which is illustrated in FIG. 7, it is explained/assumed that the ID card 40 is inserted into the card reader 54 of the first MFP 50. Notwithstanding the foregoing, however, it is possible to perform user authentication by means of or on the basis of a user name and a password in place of an authentication ID if a user enters their user name and password through keyboard (55) operation instead of inserting the ID card 40 into the card reader 54 of the first MFP 50. Specifically, if a user enters their user name and password instead of inserting the ID card 40 into the card reader 54 of the first MFP 50, user authentication is performed as follows. Upon reception of the authentication request data from the intermediary server 10, the first user authentication server 20 makes reference to the aforementioned user information table illustrated in FIG. 6 so as to make a judgment as to whether the user name and the password that are included in the received authentication request data are registered therein or not. If the user name and the password are registered in the user information table, the first user authentication server 20 outputs a favorable authentication result that approves the authentication request. On the other hand, the first user authentication server 20 outputs an unfavorable authentication result that disapproves the authentication request if the user name and the password are not registered in the user information table. The macro file illustrated in FIG. 9 contains description that enables user authentication to be performed by means of or on the basis of the user name and the password (if a user enters their user name and password instead of inserting the ID card 40 into the card reader 54 of the first MFP 50) in addition to description that corresponds to user authentication performed by means of or on the basis of the authentication ID. A non-limiting example of authentication request data that is transmitted from the first MFP 50 if a user enters their user name and password instead of inserting the ID card 40 into the card reader 54 of the first MFP 50 is illustrated in FIG. 10.

In this paragraph, the corresponding relationships between components/units described in the present embodiment of the invention and constituent elements according to an aspect of the invention are explained. The authentication request reception unit 10b that is described in the present embodiment of the invention corresponds to a “request receiving section” according to an aspect of the invention. The authentication server communication unit 10d that is described in the present embodiment of the invention corresponds to an “authentication server communicating section” according to an aspect of the invention. The authentication result transmission unit 10c that is described in the present embodiment of the invention corresponds to a “result transmitting section” according to an aspect of the invention. The first MFP 50 and the second MFP 60 that are described in the present embodiment of the invention corresponds to “a plurality of devices” according to an aspect of the invention. The model numbers of the first MFP 50 and the second MFP 60 as well as the application IDs that are described in the present embodiment of the invention corresponds to “(authentication server) determination information” according to an aspect of the invention. The setting information storage unit 10h that is described in the present embodiment of the invention corresponds to a “correspondence storing section” (i.e., corresponding relationship storing section) according to an aspect of the invention. Finally, the setting information operation unit 10i that is described in the present embodiment of the invention corresponds to a “correspondence setting section” according to an aspect of the invention. It should be noted that the aforementioned macro file that is stored in the setting information storage unit 10h contains description that indicates which user authentication server corresponds thereto. It should be noted that the explanation of the operations of the intermediary server 10 according to an exemplary embodiment of the invention given above provides a descriptive and illustrative support for not only an intermediary server according to an aspect of the invention but also a method for controlling the intermediary server according to an aspect of the invention.

The intermediary server 10 according to the present embodiment of the invention explained above receives authentication request data from a plurality of devices, a non-limiting example of which includes the first MFP 50 and the second MFP 60. The authentication request data sent from the first MFP 50/second MFP 60 is created in the common data format. Then, the intermediary server 10 according to the present embodiment of the invention explained above transmits either an authentication ID or a combination of a user name and a password in a data format that conforms to one that can be processed by (i.e., in a data format that can be processed by) the first user authentication server 20/second user authentication server 30. Therefore, when an original data format that conforms to one which is accessible (can be processed) by the first user authentication server 20/second user authentication server 30 is changed for any reason into another data format or when there is an addition of another user authentication server, it is not necessary to change the setting/configuration of each of the plurality of MFPs 50, 60 on an individual basis. That is, when such change or addition occurs, it is possible to make an authentication system work by changing the setting/configuration of the intermediary server 10 only. For this reason, the intermediary server 10 according to the present embodiment of the invention described above releases users from the burden of setting changes when such change or addition occurs. In the preceding sentence, the phrase “changing the setting/configuration of the intermediary server 10” includes, without any limitation thereto, the initial registration of a new macro file, the modification/change of an existing/registered macro file, and the deletion of an existing/registered macro file. Herein, the initial registration of a new macro file means the addition of another macro file as a new entry. In addition to the above, the phrase “changing the setting/configuration of the intermediary server 10” of the preceding sentence includes, without any limitation thereto, the initial registration of a new server module, the modification/change of an existing/registered server module, and the deletion of an existing/registered server module. Herein, the initial registration of a new server module means the addition of another server module as a new entry.

Needless to say, the invention should be in no case understood to be restricted to the exemplary embodiment thereof described above. That is, the invention may be configured or implemented in an adaptable manner in a variety of variations or modifications thereof without departing from the spirit thereof, which should be deemed to be encompassed within the technical scope thereof.

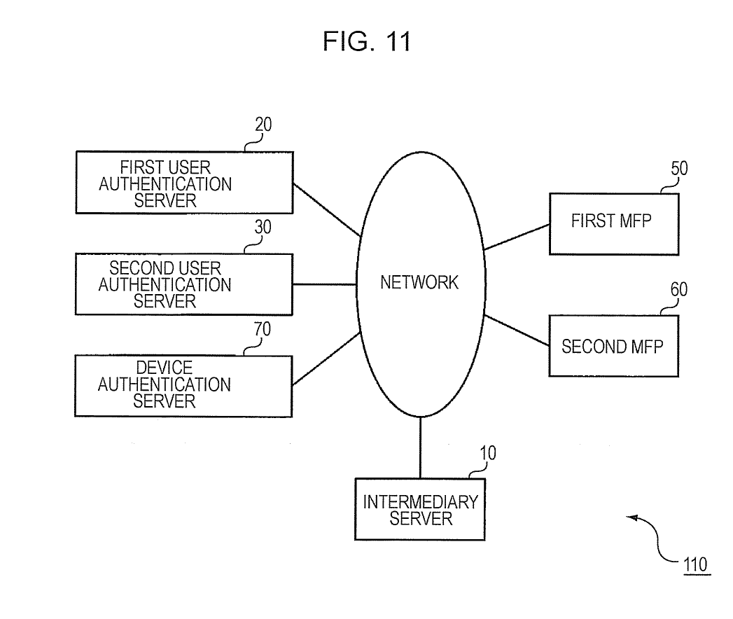

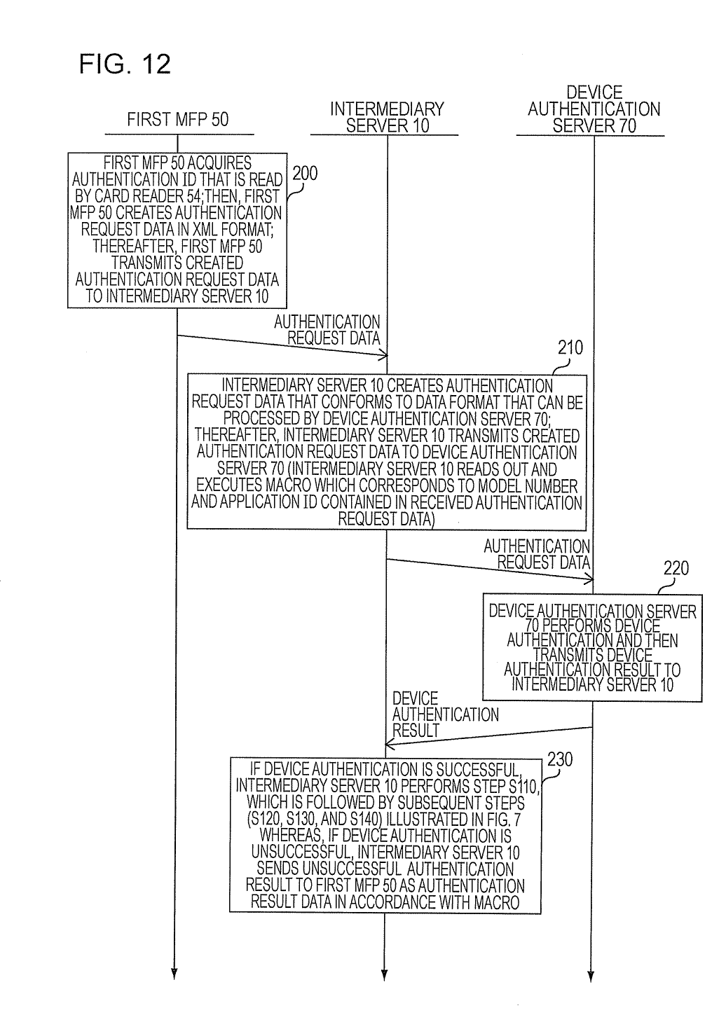

In the configuration of the authentication system 100 according to the foregoing exemplary embodiment of the invention, it is explained that all of a plurality of authentication servers are provided/configured as user authentication servers. However, the scope of the invention is not limited to such an exemplary configuration. As a non-limiting modified configuration thereof, an authentication system 110 illustrated in FIG. 11 has (may have) a device authentication server 70 in addition to the first user authentication server 20 and the second user authentication server 30. In such a modified configuration of the authentication system 110, the device authentication server 70 performs “device authentication” so as to make a judgment as to whether the sender of authentication request data (e.g., the first MFP 50 or the second MFP 60) is listed as the target of user authentication or not. Then, the intermediary server 10 issues a request for user authentication to the first user authentication server 20 or the second user authentication server 30, which is determined (e.g., identified, though not limited thereto) on the basis of the authentication request data, only if the sender of authentication request data is listed as the target of user authentication. In the following description, the sequence/flow of data communication conducted by the modified authentication system 110 is explained while making reference to FIG. 12. The following explanation is based on an assumption that the intermediary server 10 receives authentication request data with/after the selection of a copy mode from the first MFP 50. It is further assumed herein just for the purpose of explanation that, prior to the reception of the authentication request data by the intermediary server 10 from the first MFP 50, a user inserts their ID card 40 into the card reader 54 of the first MFP 50. Upon the recognition of the insertion of the ID card 40 into the card reader 54 thereof, the first MFP 50 acquires the authentication ID of the ID card 40 that is read by the card reader 54. Then, the first MFP 50 creates, in the aforementioned common data format, authentication request data that includes the authentication ID, the IP address, the model number “X”, and the application ID “1”, which indicates the use of a copy function (refer to the table of FIG. 3). Thereafter, the first MFP 50 transmits the created authentication request data to the intermediary server 10. The above-explained series of the acquisition of the authentication ID, the creation of the authentication request data, and the transmission thereof constitutes the first step of the data communication flow described herein (step S200). The intermediary server 10 takes the authentication ID, the IP address, the model number X, and the application ID 1 out of the received authentication request data. Then, while making reference to the aforementioned macro-setting table that is shown in FIG. 4, the intermediary server 10 reads out the macro file name “X1.txt”, which corresponds to, that is, associated with, the model number X and the application ID 1. The intermediary server 10 performs processing in accordance with the content of the macro file. Specifically, the intermediary server 10 creates authentication request data (including the model number and the IP address) that conforms to a data format that can be processed by the device authentication server 70; and thereafter, the intermediary server 10 transmits the created authentication request data to the device authentication server 70 (step S210). Upon reception of the authentication request data from the intermediary server 10, the device authentication server 70 performs device authentication, and then transmits the result of the device authentication to the intermediary server 10 (step S220). Specifically, upon reception of the authentication request data from the intermediary server 10, the device authentication server 70 makes a judgment as to whether the model number and the IP address contained in the received authentication request data are registered in a device information database that is stored in a memory unit thereof or not. Note that the memory unit is not shown in the drawing. If the model number and the IP address are registered in the device information database, the device authentication server 70 outputs a favorable authentication result that recognizes/interprets that the original sender of the authentication request data, that is, the first MFP 50 in this example, is a device that is listed as the target of user authentication (i.e., successful device authentication). On the other hand, if the model number and the IP address are not registered in the device information database, the device authentication server 70 outputs an unfavorable authentication result that recognizes/interprets that the original sender of the authentication request data, that is, the first MFP 50 in this example, is not a device that is listed as the target of user authentication (i.e., unsuccessful device authentication). Then, the device authentication server 70 transmits the result of the authentication, which is either authentication OK or authentication NG, to the intermediary server 10. Upon reception of the result of the device authentication from the device authentication server 70, the intermediary server 10 performs, if the result of the device authentication is a success, the aforementioned step S110, which is followed by subsequent steps (S120, S130, and S140) illustrated in FIG. 7 in accordance with the aforementioned macro except that the first MFP 50 displays, in place of a message that approves or disapproves the requested log in and administrative configuration/setting, a message that approves or disapproves the requested use of a copy function on the liquid crystal display 56 (step S230). On the other hand, in this step S230, if the result of the device authentication is a failure, the intermediary server 10 sends the unsuccessful authentication result to the first MFP 50 as the aforementioned authentication result data. If the result of the device authentication is a failure, the first MFP 50 displays a message that informs the user that the device itself, that is, the first MFP 50, is not listed as the target of user authentication on the liquid crystal display 56. With such a modified configuration, it is possible to perform user authentication only for some devices that are listed as the target of user authentication.

In the configuration of the authentication system 100 according to the foregoing exemplary embodiment of the invention, it is explained that the authentication system 100 includes the first user authentication server 20 and the second user authentication server 30. However, the scope of the invention is not limited to such an exemplary configuration. As a non-limiting modified configuration thereof, the authentication system 100 may include the first user authentication server 20 only. Even if such a modified configuration is adopted, when an original data format that conforms to one which is accessible (can be processed) by the first user authentication server 20 is changed for any reason into another data format or when there is an addition of another user authentication server, it is not necessary to change the setting/configuration of each of the plurality of MFPs 50, 60 on an individual basis. That is, when such change or addition occurs, it is possible to make an authentication system work by changing the setting/configuration of the intermediary server 10 only. For this reason, users are released from the burden of setting changes when such change or addition occurs.

In the configuration of the authentication system 100 according to the foregoing exemplary embodiment of the invention, it is explained that the first MFP 50 is provided with the card reader 54 that is capable of reading the authentication ID of the ID card 40. However, the scope of the invention is not limited to such an exemplary configuration. As a non-limiting modified configuration thereof, the first MFP 50 may be connected to a biological information reading apparatus. In such a modified configuration, the biological information reading apparatus is provided in addition to or in place of the card reader 54. Examples of the biological information reading apparatus include but not limited to a biometrics information reading apparatus, a fingerprint reading apparatus, an iris reading apparatus, and a vein pattern reading apparatus. In such a modified configuration, information that is read by the biological information reading apparatus is transmitted as ID information to the intermediary server 10.

In the configuration of the authentication system 100 according to the foregoing exemplary embodiment of the invention, it is explained that user identification information and authentication server determination information, the latter of which is used for determining (e.g., identifying, though not limited thereto) the first user authentication server 20 or the second user authentication server 30, are separated from each other. That is, in the foregoing explanation of the authentication system 100 according to an exemplary embodiment of the invention, the user identification information (e.g., an authentication ID or a combination of a user name and a password) and authentication server determination information (e.g., the model number of the first MFP 50/second MFP 60 and an application ID) are separated from each other. However, the scope of the invention is not limited to such an exemplary configuration. As a non-limiting modified configuration thereof, user identification information may double as, for example, contain, authentication server determination information. As a non-limiting example thereof, the last-digit number of the user identification information may be used for determining (e.g., identifying, without any limitation thereto) the user authentication server.

In the configuration of the authentication system 100 according to the foregoing exemplary embodiment of the invention, a user authentication server(s) is taken as an example of a variety of authentication servers. However, the scope of the invention is not limited to such an exemplary configuration. As a non-limiting modified configuration thereof, an accounting server(s) that makes a judgment as to the approval/disapproval of use may be used as an authentication server(s).

The entire disclosure of Japanese Patent Application No. 2007-186614, filed Jul. 18, 2007 is expressly incorporated by reference herein.

What is claimed is:

1. An intermediary server that intermediates between at least one authentication server that performs authentication and a plurality of devices that performs various kinds of processing in accordance with the result of the authentication performed by the authentication server, the intermediary server comprising:
a request receiving section that receives authentication request data from any of the plurality of devices, the authentication request data being created in a predetermined common data format in such a manner that the authentication request data contains, without any limitation thereto, identification information that was inputted into the above-mentioned one of the plurality of devices;
an authentication server communicating section that transmits the received identification information to the authentication server in a data format that can be processed by the authentication server and then receives, from the authentication server, the result of authentication performed by the authentication server on the basis of the transmitted identification information; and
a result transmitting section that transmits the received result of the authentication to the above-mentioned one of the plurality of devices that is the original sender of the authentication request data.

2. The intermediary server according to claim 1, further comprising:
a correspondence storing section that pre-stores correspondences between determination information, which enables a determination of the authentication server, and the authentication server; and
a correspondence setting section that enables a new correspondence to be registered into the correspondence storing section and further enables any correspondence that is registered in the correspondence storing section to be changed or deleted,
wherein the above-mentioned at least one authentication server is not one but more than one authentication server;
the request receiving section receives authentication request data from any of the plurality of devices, the authentication request data being created in the predetermined common data format in such a manner that the authentication request data contains, without any limitation thereto, identification information that was inputted into the above-mentioned one of the plurality of devices and the determination information; and
the authentication server communicating section determines the authentication server that corresponds to the received determination information on the basis of correspondences stored in the correspondence storing section, transmits the received identification information to the determined authentication server in a data format that can be processed by the determined authentication server, and then receives, from the determined authentication server, the result of authentication performed by the determined authentication server on the basis of the transmitted identification information.

3. The intermediary server according to claim 2,
wherein the above-mentioned more than one authentication server includes but not limited to at least one user authentication server that performs user authentication and a device authentication server that performs device authentication;
the request receiving section receives authentication request data from any of the plurality of devices, the authentication request data being created in the predetermined common data format in such a manner that the authentication request data contains, without any limitation thereto, identification information that was inputted into the above-mentioned one of the plurality of devices, identification information that is unique to the above-mentioned one of the plurality of devices, and the determination information;
the authentication server communicating section transmits the received device identification information to the device authentication server in a data format that can be processed by the device authentication server and then receives, from the device authentication server, the result of device authentication performed by the device authentication server on the basis of the transmitted device identification information; and
the authentication server communicating section determines, if the received result of the device authentication is a success, the user authentication server that corresponds to the received determination information on the basis of correspondences stored in the correspondence storing section, transmits the received identification information to the determined user authentication server in a data format that can be processed by the determined user authentication server, and then receives, from the determined user authentication server, the result of user authentication performed by the determined user authentication server on the basis of the transmitted identification information.

4. The intermediary server according to claim 2, wherein the correspondence storing section pre-stores the correspondences in the form of script files.

5. A method for controlling, by means of a computer software, an intermediary server that intermediates between at least one authentication server that performs authentication and a plurality of devices that performs various kinds of processing in accordance with the result of the authentication performed by the authentication server, the intermediary server controlling method comprising:
receiving authentication request data from any of the plurality of devices, the authentication request data being created in a predetermined common data format in such a manner that the authentication request data contains, without any limitation thereto, identification information that was inputted into the above-mentioned one of the plurality of devices;
transmitting the received identification information to the authentication server in a data format that can be processed by the authentication server and then receiving, from the authentication server, the result of authentication performed by the authentication server on the basis of the transmitted identification information; and
transmitting the received result of the authentication to the above-mentioned one of the plurality of devices that is the original sender of the authentication request data.

6. A program that causes at least one computer to execute the steps of the intermediary server controlling method according to claim 5.
